(19) United States
(12) Patent Application Publication
(10) Pub. No.: US 2009/0199093 A1
(43) Pub. Date: Aug. 6, 2009

(54) Image Capture And Sharing System and Method

(76) Inventor: Tridib Chakravarty, Fullerton, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/204,748

(22) Filed: Sep. 4, 2008

Related U.S. Application Data
(60) Provisional application No. 60/969,914, filed on Sep. 4, 2007.

(51) Int. Cl. G06F 17/00; G06F 3/048

(52) U.S. Cl. 715/273; 715/781

(57) ABSTRACT

An image capture and sharing system and method are disclosed. A viewing space is provided in a browser window of a browser application. An image capture tool receives image information into the viewing space from images displayed in one or more web pages obtained by the browser application. Tag information associated with the images is received and associated with the image information. The image information is displayed in the viewing space according to an arrangement. A metabase of the tag information is created and is accessible by a user command directed to associated image information in the viewing space.

### CROSS REFERENCE TO RELATED APPLICATIONS

The present application claims priority under 35 U.S.C. §119 to U.S. Provisional Application Ser. No. 60/969,914, filed Sep. 4, 2007, entitled “Image Capture and Sharing System and Method” the disclosure of which is incorporated herein by reference.

### BACKGROUND

This disclosure relates generally to web based image collection and sharing tools.

As the saying goes, “a picture is worth a thousand words.” Pictures, or images in the case of a digital medium such as the Internet or “Web,” present a variety of complex descriptions and stories, depending on the goals or even lack thereof, of intended visualization. A single image can be more influential on a viewer than a substantial amount of text. Accordingly, a collection of images can be exponentially influential on the viewer, and in today's world of instantaneous transmission of digital information to other viewers, collections of images can have profound influence on all types of behaviors of their viewers.

The web has for a long time presented a highly static portal for images. Images have been treated like text where they are often even today statically linked with text on web pages. We rely on the images themselves for interactivity. However humans view images and pictures very differently from text. Humans think in a more free form manner when it comes to images. As an example, given two text articles, humans tend to read each one of them and then mentally compare notes etc. However if given two images, humans rarely view them in isolation like text. Humans tend to move them around, compare them, and this leads to a very different experience. Up until now the web has however limited users to an experience that is similar to text, where all content has been treated equally. There are a number of visual shopping sites that aim to create mashups from other shopping sites. They use some hints of putting images together, but only offer static views.

Web page and Photo Creation sites include social networking sites allows a user to lay out or organize a page with various forms of media, including photos. Some sites offer templates for putting together stories, but once populated, these templates are static and do not provide free form image manipulation. Still other photo-specific sites are aimed at providing virtual “scrap books.” However, these sites are constrained by a scrap book creation tool in the form of a non-web based application.

Photo Manipulation Sites: These sites are mostly flash based and aimed at uploading your image and then adding a funny effect. Then the effects are either linked to another social networking site or downloaded as a jpeg or another image format.

Social bookmarking sites allow users to bookmark the web and place the bookmarks on their site. There are a number of sites and each takes a slightly different approach on displaying the sharing bookmarks. However, they all work similarly in that an image (almost always a thumbnail preview) and some text (which can be selected in some and chosen automatically in others) are placed on the social bookmarking site. The linked bookmarks are just regular web based static sites. There is no special attention given to images. Hence the experience in social bookmarking today is once again similar for text based links or image based links.

For importing images from a website, every conventional import technique relies on a process that includes requesting the image from the hosting server. So as an example if a user were to visit a photo-hosting site such as www.flickr.com and wanted to get an image into an album on a photo-sharing site such as Photobucket, the user must specify the URL of the flickr image into an “Upload from URL” application on the photo-sharing site. The photo-sharing site then proceeds to make a request to Flickr, which then delivers the image to the photo-sharing site.

While this mechanism works, it has some major drawbacks. If the content is behind a password-protected site, there is no way to get the image without knowing user credentials, which becomes a painful user experience as the user has to specify all user names and passwords. Further, many times the image displayed is overlayed with a transparent fake image which prevents a user from scraping or downloading the image. A hosting site like Flickr can, at any moment, decide to stop sending images, and the user would not be able to import any images from the hosting site if so blocked.

### SUMMARY

In general, this document discusses a system and method for capturing, manipulating, sharing and using images.

The details of one or more implementations are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates an image scrap tool having a wall and “favorite” bucket to apply to the wall.

FIG. 2 illustrates a “zoom in” of the wall shown in FIG. 1.

FIG. 3 illustrates a “zoom out” of the wall shown in FIG. 1.

FIG. 4 depicts a representative of Google Image Search results.

FIG. 5 depicts a “right click” operation on the Google Image Search results.

FIG. 6 depicts a resulting page of an image import operation.

FIGS. 7-10 depict a particular application of the system.

Like reference symbols in the various drawings indicate like elements.

### DETAILED DESCRIPTION

This document describes a web-enabled picture/image/notes “scrap” tool. The scrap tool generates a “wall,” a space as a view in a browser window. The wall can initially be blank, and have features such as a background color (i.e. white, black, or any other color), border, which can be dynamically resizable, or other features. Images, notes, text or other elements from one or more “buckets” that have been created are then uploaded to this space. The elements uploaded can then be moved on the wall and arranged into scraps. Once arranged the wall can be flexibly and dynamically traversed, representing the free-flow expression of a user's ideas through imagery, text, other media and manipulation thereof. Each wall can then be shared among different users.

The main components include walls—the free flow space in the browser window; buckets—a collection of elements, arranged in an order such as folders, hierarchical, etc.; and elements—images, text, etc.

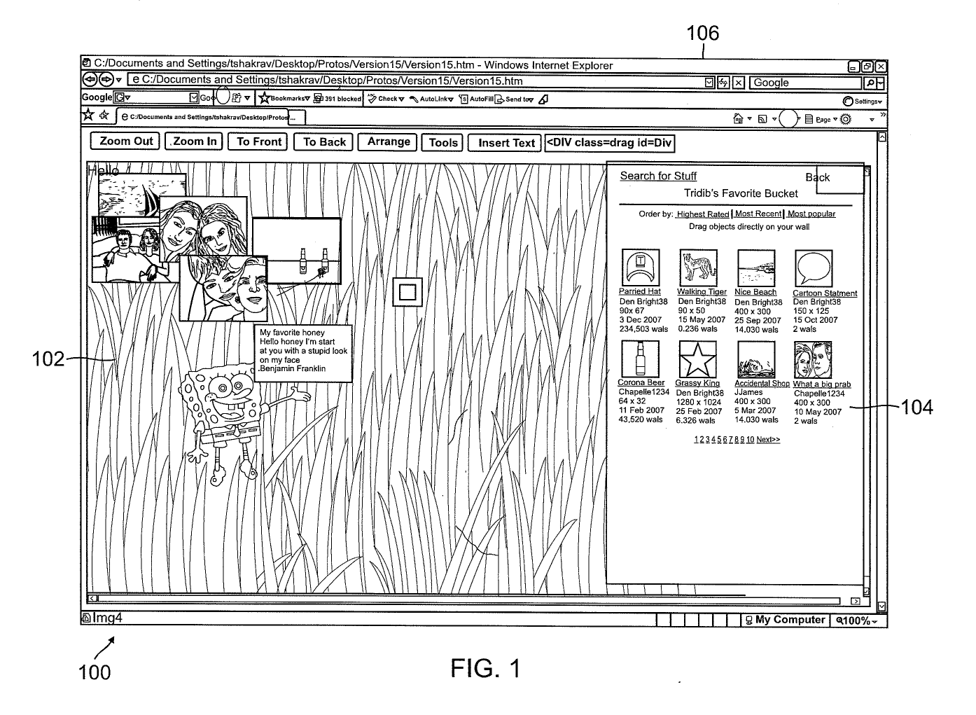

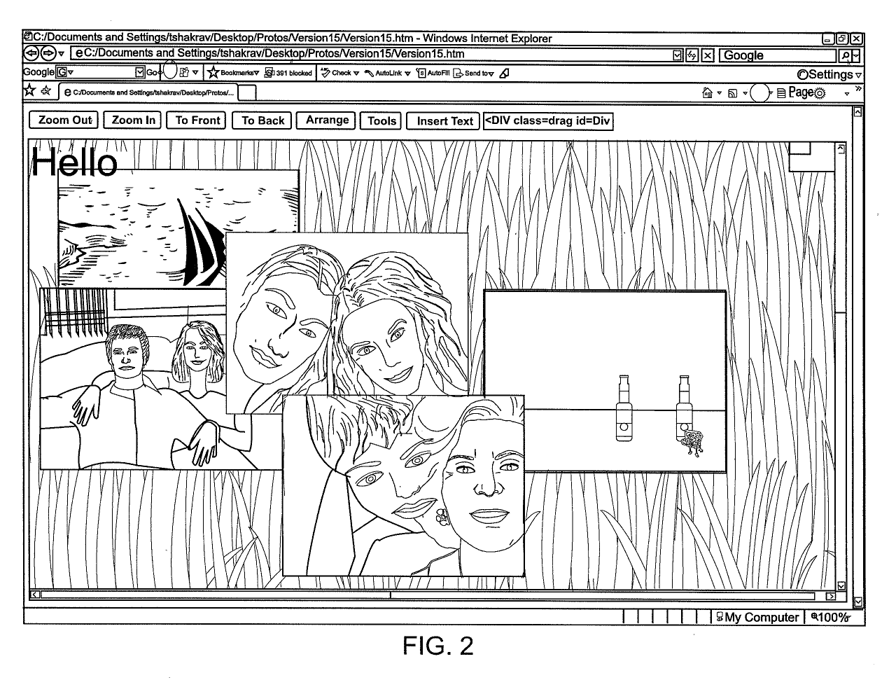

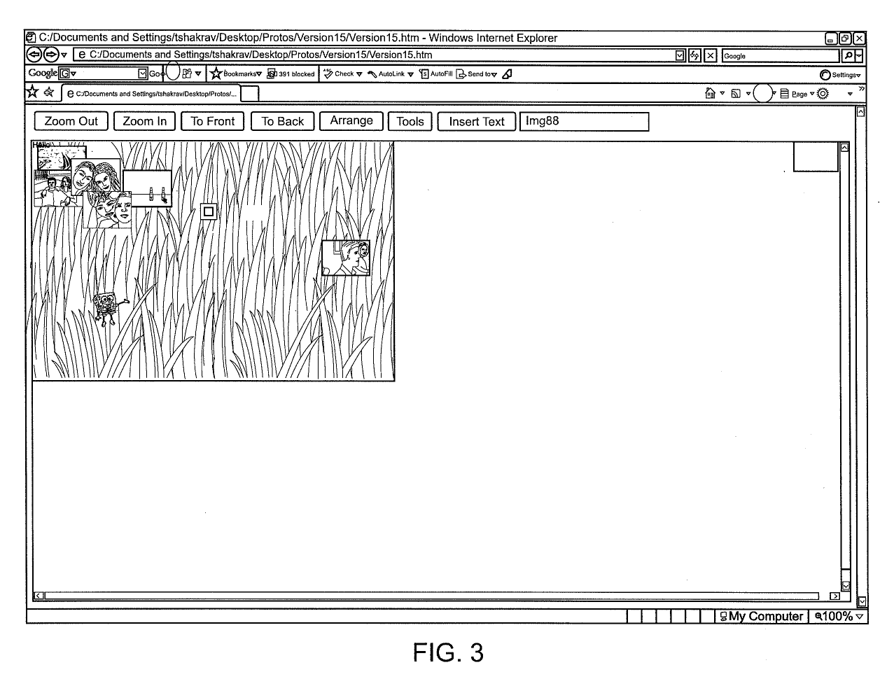

FIG. 1 illustrates an image scrap tool 100 having a wall 102 and “favorite” bucket 104 to apply to the wall, all provided in a browser 106. FIG. 2 illustrates a “zoom in” of the wall 102 shown in FIG. 1, and FIG. 3 illustrates a “zoom out” of the wall 102 shown in FIG. 1.

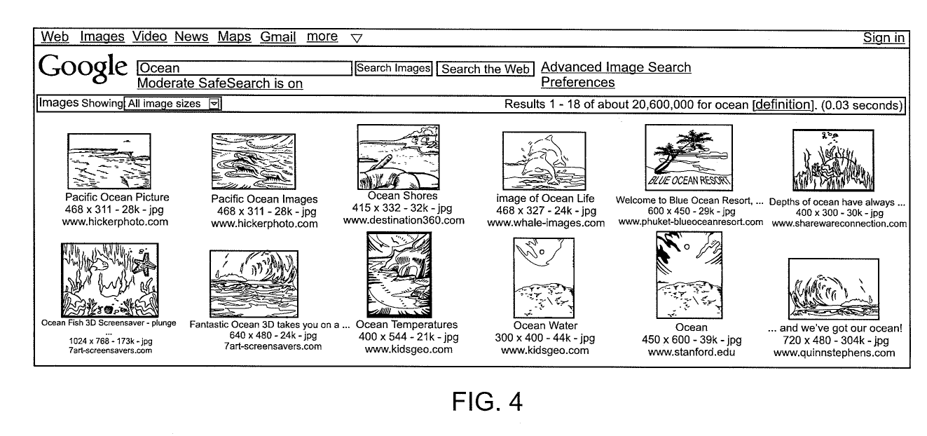

The system allows users to “pull” images from other sites, such as a portal site or search site as illustrated in FIG. 4, which automatically allows those users to collect metadata (i.e. prices, other information), and to tag metadata. All the information, such as metadata and tags, is then stored in the system database. The metadata and tags allow each wall to become a visual bookmark site, i.e. images can be clicked on to access metadata for Internet shopping. This offers a useful mechanism for various applications: such as, for example but without limitation, Photo Sites, Notes, Storyboarding, shopping, via tags and metadata and links via selected images, etc.

The system and method provide an alternate global web world for images or other visually rich content. The system and method provide a web-driven image tool that offers the ability to create a free form application catered to images. Some of the attributes are, without limitation: 1) the workspace is not a limited area bound by the screen size but an extremely large space that can be zoomed in and out and traversed; 2) ability to drag images in dynamically through a simple drag and drop; 3) ability to resize images dynamically; 4) ability to move images next to each other, superimpose images and embed an image into one or more other images.

The system and method provides a truly visually free way of interacting with images. This interactivity is relevant in a number of activities, as follows:

Photo Tool: Since this web application provides the ability to interact with images in a free form, it is highly engaging as a photo tool. One can imagine creating collages, scraps, adding funny doodles to pictures like embedding a beard graphic on the picture of your friend etc.

Art Tool: As images can be placed side by side, this enables an easy way to create visual form of art by virtue of its underlying ability—Comparison Tool: Images can now be easily placed next to each other or compared for any number of decision making purposes

Another aspect includes providing users an easy portal for “PULLING” images from the web. As users browse, they will be interested in pulling images from regular web sites into the media rich space of a wall of the system. The system enables users to easily pull content from any website, such as using a browser plugin and later as web links embedded in other sites. With the content that is pulled, the system logs some or all of the following:

Site/URL from which the image came. This is exposed to the user for the user to manipulate the image as desired.

Original URL of the image this is kept by the system internally for search results.

Any user provided tags describing the image.

A description of the image or related to the image.

Any metadata about the image that can be pulled through scraping or APIs on the site.

As media is pulled in and images get tagged, a side effect is the creation of a global metabase of images on the web. This global metabase can then be used to provide a world wide search repository for images as we have the tags and the originating URLs. Once images are pulled in, users can use a free form image application for any of the above mentioned purposes. As the originating link is always stored, users can always return to the original URL through a simple click of the URL from the system's site. The functionality of the system results in users importing the images from the internet that they are naturally interested in. This results in the site provided by the system to act as a filter for interesting images rather than all images. This further adds to an ability to provide search results that are truly interesting to users.

Another feature is that every image pulled into the system can be categorized using tags. The system does not use the traditional folder structure. Tags make partitioning and searching of images easier. As an example, consider a user that has imported a few images from Google Image Search. On a first search the user typed (1) “Beach House.” The user imports a few images and the system automatically tags the images with “Beach”, “House”. (2) Then, the user performs the following search to narrow the results “Beach House Hawaii”. The user imports another few images which now get tagged “Beach”, “House”, “Hawaii”. (3) The user then decides to perform a more specific search “Beach House Hawaii Maui”, and then imports some more images into the system.

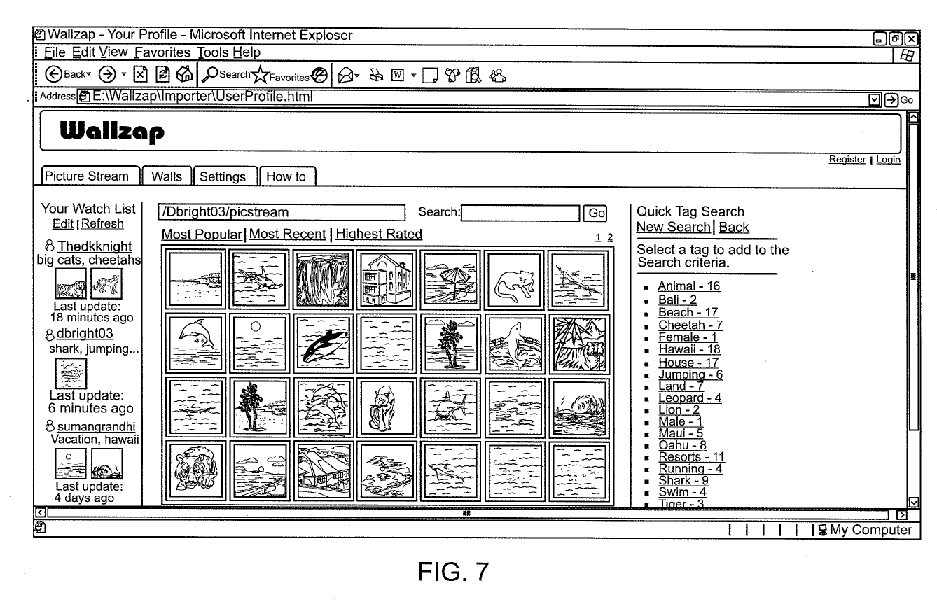

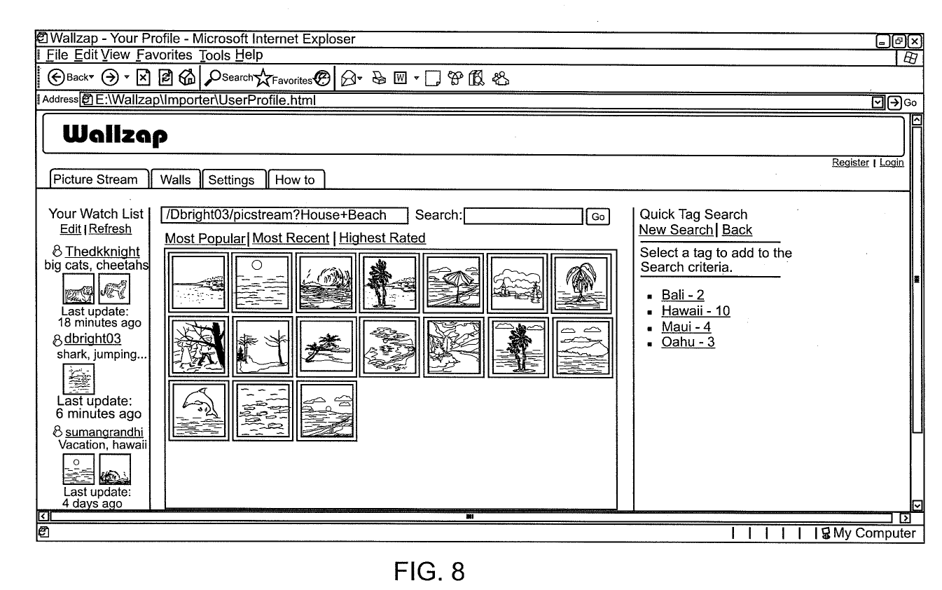

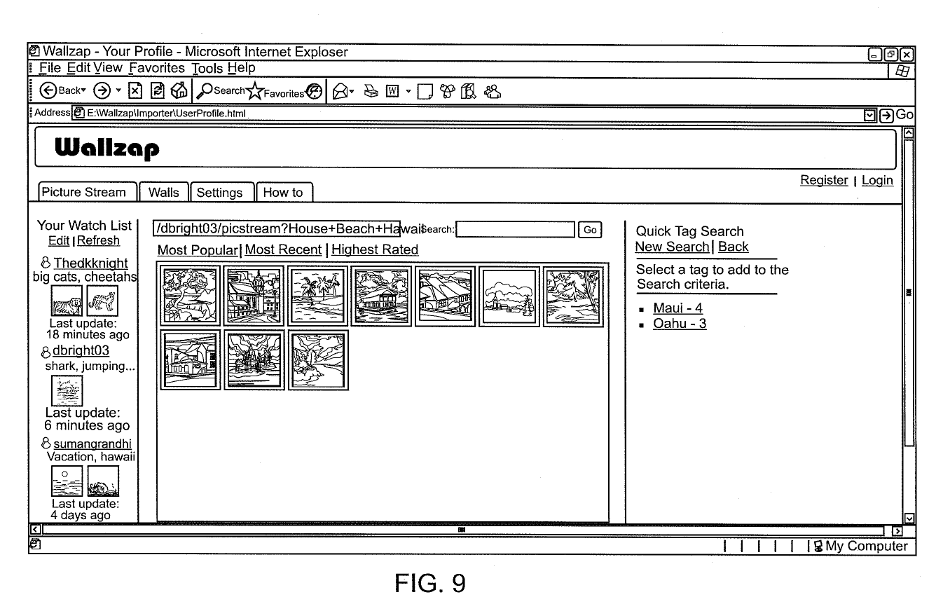

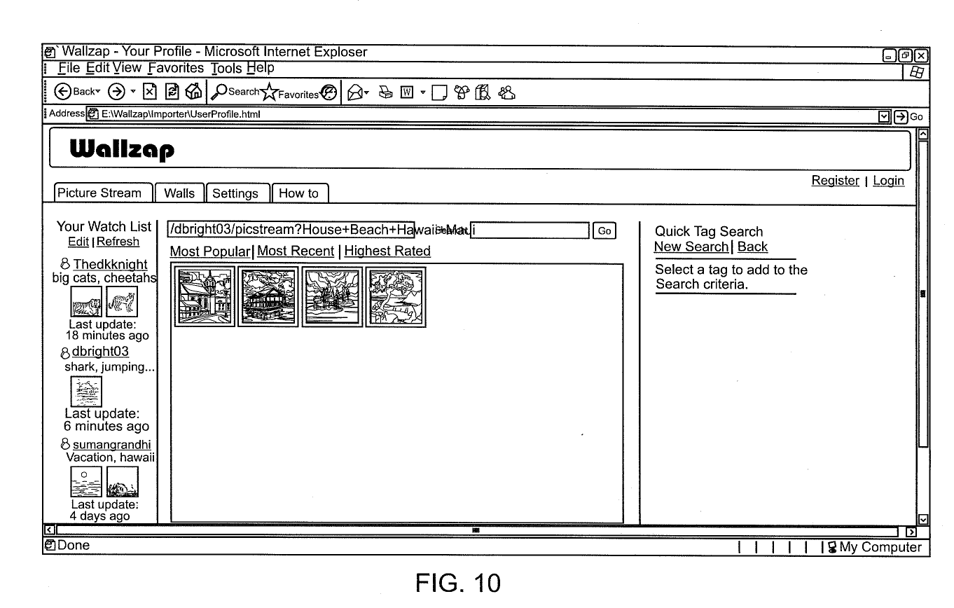

Now when the user goes back to their images on the system, they see a page (FIG. 7) of images and tags. Now if the user clicks on the “House” +“Beach” tag, the displayed images are now all images tagged with House and Beach (FIG. 8). Image results can further be narrowed by adding “Hawaii”, to display images that are tagged with each of “Hawaii” +“Beach” +“House”. The search can be further narrowed as seen in FIG. 9, with the tags “Hawaii” +“Beach” +“House” +“Maui”, which yields even further narrowed search images. This applies to a number of situations and tags, and gives users a flexible way to create search lists. Such application of tags to images creates a new search capability.

Security: walls can be shared, viewed, and/or edited by the creating user, by friends (i.e. select other users the creating user designates), or even by all other users (i.e. “public”). Buckets and elements can also be shared, viewed, and/or edited similarly. Thus, walls, buckets and elements will show or not be shown based on search, i.e. if a user puts a private image on a public wall, the image will become public.

Revenue can be based on links and/or clicks to shopping sites, database searches of image tags, and vendors putting up walls for advertising. Another revenue stream is to tie up with content providers for allowing users to import content for a fee. So as an example, if a user visited perfect10.com and tried to import an image, the system detects the site and conveys a message such as “you can import a legal copy for 10 cents.” Since these sites are losing a lot of money to illegal downloads, this the user a legal copy while thwarting the illegal downloads. The system now has a legitimate copy for hosting, or to be registered on a “partners” network where users can import to the system for a small fee. For partners that do not want to allow importation of their images to the system, the system can generate a message regarding the prohibition of importation consistent with the settings of the partner.

### Image Import From Other Web Sites

The system enables its users to seamlessly import an image from the web as they browse other web sites and images. Along with the image content, the system enables the user to specify some information (tags, description, hosting page URL link, etc.) and also collect some information automatically (image URL link, size, tags etc.).

The system includes functionality to ensure that users can always successfully import an image. To do that, if a user browsed to a web URL and then to an image, then that image should already exist in the user's browser cache. Then, when a user uses the system import mechanism (either through a “right click,” a toolbar extension, or any other mechanism), the URL of the image is taken, a translation to what the name of the image is in the browser's local cache is performed, and that local cache file is used to perform an upload to the system. This means that the system never sends a file request to the hosting site. The hosting site will actually never see anything out of the ordinary. Similarly, even if the content is residing behind a password-protected site, if the user is able to browse and view the content, the system can translate and upload the content from the local cache.

### Thumbnail Based Importing

The system includes a mechanism and a process to easily import images from other web sites. These images are stored on the system, for display in one or more walls, with the originating URL of the hosting page, allowing the user to return back to the original context of the image using the URL link.

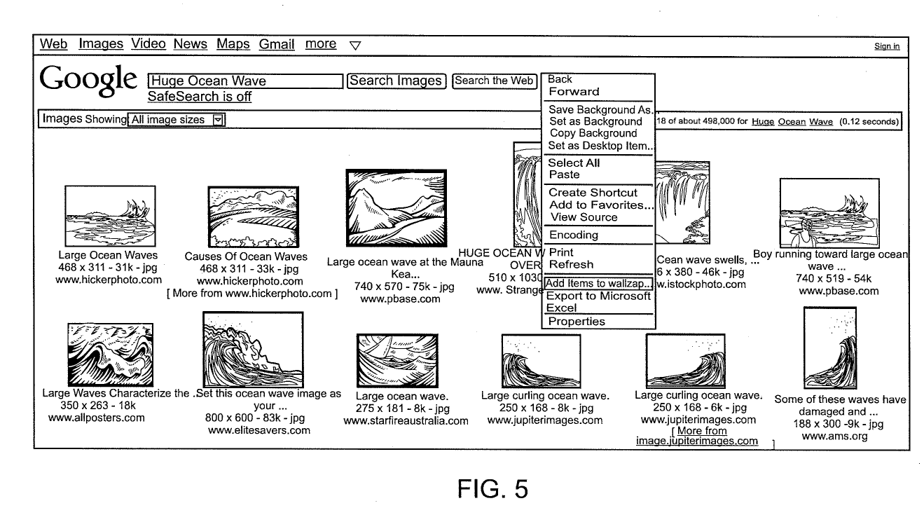

In many image-based sites such as Google Image Search, Picasa Web Photos, Kodak Easy Share Gallery, etc. a large number of image results are shown on a single page, as shown in FIG. 4, which depicts a Google Image Search results. In this scenario, a user would have to visit each individual image by clicking on the thumbnail and then proceed to import the high-resolution image using the system's importer. Instead, the system enables the user to right click on the results page, as shown in FIG. 5.

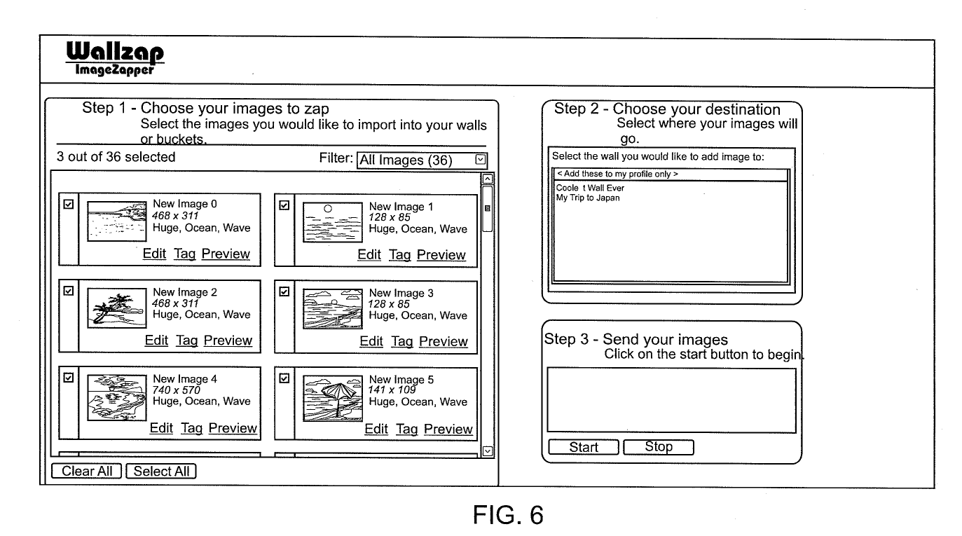

The next page, as shown in FIG. 6, contains a list of the thumbnails along with the high-resolution image also available for importing, without the user ever having to navigate to the high-resolution image. In this example, the high resolution image has been dynamically loaded in by the system. FIG. 6 illustrates the system's Image Importer dynamically fetching high-resolution images.

Once the images are selected (which can be a selection of both high and low resolution), the images are transferred. Whenever an image listing that has been retrieved based on a search, e.g. Google Search, Live Search, Yahoo Image Search etc., the results are retrieved based on search criteria. In the above example, the images were retrieved using “Huge Ocean Wave”. An important side effect is that the search terms may also represent highly relevant tag word candidates. Accordingly these images, when imported into the system, are automatically tagged with the search criteria, thereby allowing the system to easily build the same database of tags as the underlying search engine.

### Addressing the Issue of Image Checksumming/Hashing

The system keeps a unique image/file checksum for every image uploaded. A file checksum is useful for many reasons, namely a checksum uniquely identifies an image and can thus help detect duplicate images, and a checksum can help easily identify dubious content, which may be copyrighted or illegal. If the checksum is determined or known, the content can be flagged on an upload or all instances of it can be detected.

The issue with checksums is that computing them is very CPU intensive. When the system has a large number of images being constantly uploaded, the CPU load for computing checksums is prohibitive, requiring an extremely large number of servers to perform the hashing alone.

To address this issue, the system spreads the checksum function load to the end user's system. Based at least in part on the discussion above regarding Image Import from Other Web Sites, since images are uploaded from the end-user's cache, the system can perform the checksum on the end user's system even prior to the uploading. This allows the system to reduce server-side CPU utilization for checksumming to zero, and further allows the system to run checks against the checksum even before the upload is performed.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A computer-implemented image capture and sharing method comprising:
providing a viewing space in a browser window of a browser application;
receiving image information into the viewing space from images displayed in one or more web pages obtained by the browser application;
receiving tag information associated with the images;
associating the tag information with the image information;
displaying the image information in the viewing space according to an arrangement; and
generating a metabase of the tag information, the metabase being accessible by a user command directed to associated image information in the viewing space.

2. The method in accordance with claim 1, further comprising receiving attribute commands from a user to manipulate the image information in the viewing space according to one or more attributes.

3. The method in accordance with claim 2, wherein the one or more attributes include an image size.

4. The method in accordance with claim 1, wherein the tag information includes metadata.

5. The method in accordance with claim 1, wherein the tag information includes a link to a source web page of an associated image from the one or more web pages.

6. The method in accordance with claim 1, wherein the arrangement includes a free-form arrangement.

7. The method in accordance with claim 1, further comprising formatting the viewing space and associated metabase into an electronic file.

8. An image capture and sharing system comprising:
a viewing space in a browser window of a browser application;
an image capture tool to receive image information into the viewing space from images displayed in one or more web pages obtained by the browser application, to receive tag information associated with the images, to associate the tag information with the image information, and to display the image information in the viewing space according to an arrangement; and
a metabase of the tag information, the metabase being accessible by a user command directed to associated image information in the viewing space.

9. The system in accordance with claim 8, further comprising a sharing tool to format the viewing space and associated metabase into an electronic file.

10. The system in accordance with claim 8, further comprising a toolbar to allow a user to change attributes of the image information in the viewing space.

11. A computer-implemented image capture and sharing method comprising:
providing a viewing space in a browser window of a browser application;
receiving image information into the viewing space from images displayed in one or more web pages obtained by the browser application;
receiving tag information associated with the images;
associating the tag information with the image information;
displaying the image information in the viewing space according to an arrangement;
generating a metabase of the tag information, the metabase being accessible by a user command directed to associated image information in the viewing space; and
formatting the viewing space and associated metabase into an electronic file that can be displayed by the browser and transmitted over a network to another computer.
